(19) United States
(12) Patent Application Publication
(10) Pub. No.: US 2020/0000675 A1
(43) Pub. Date: Jan. 2, 2020

(54) HIGHLY SENSITIVE SEXUAL AID DEVICE

(71) Applicant: Shoham GOLAN, Netanya (IL)

(72) Inventor: Shoham GOLAN, Netanya (IL)

(21) Appl. No.: 16/451,573

(22) Filed: Jun. 25, 2019

(30) Foreign Application Priority Data
Jun. 28, 2018 (IL) 260328

(51) Int. Cl. A61H 19/00; A61H 9/00; A63H 3/00

(52) U.S. Cl. CPC A61H 19/44; A61H 9/0078; A63H 3/003; A61H 2201/1246; A61H 2201/1409; A61H 2201/5007; A61H 2201/5082; A61H 2201/169; A61H 2201/1652; A61H 2201/0119; A61H 2201/5071

(57) ABSTRACT

A sexual aid device, for allowing a user being a first party of sexual relationship with a second party, to simulate the physiologic reaction of the penis of a human male, which comprises a hollow penis body made of flexible or semi-rigid material and containing an inflatable air or fluid tube for causing the penis body to be in its erected state when the inflatable air or fluid tube is maximally inflated and for allowing the penis body to be in its descended default state, when the inflatable air or fluid tube is deflated; a simulated scrotum made of flexible or semi-rigid material, having a compartment for containing means for controlling the inflation and deflation of the air or fluid tube; a pump for inflating the air or fluid tube; a controllable valve for deflating the air or fluid tube; one or more sensors located on the penis body, for detecting physical contact of the penis body with the body of the second party; a controller for controlling the controllable valve to be closed and the pump to inflate the air or fluid tube up to a maximal pressure, according to input signals received from the sensors and to deflate and the controllable valve to be open and deflate the air or fluid tube, according to different input signals received from the sensors; a power source for powering the controller, the pump, the valve and at least one sensor; means for attaching the sexual aid device to the body of the first party.

### FIELD OF THE INVENTION

The invention disclosed herein relates generally to sexual aids. More particularly, the invention relates to a sexual aid device, which automatically emulates the human penis physiological behaviors with high sensitivity.

### BACKGROUND OF THE INVENTION

There is a growing acceptance of sexuality, as exhibited by a growing demand for sexual devices. Prior to these changes, many sexual aid devices were sold for sexual pleasure, although primarily under the euphemistic names and a pretense of providing massage services.

Modern sexual aid devices fall broadly into two classes: mechanized and non-mechanized. Mechanized devices typically vibrate, although there are types that can rotate, thrust, and even circulate small beads within an elastomeric shell. Non-mechanized devices, such as a dildo (an artificial erect penis, used as a sexual aid) to an erotic vibrator (a device often used to attain an orgasm by its vibration mechanism) are made from solid, rigid or semi-rigid materials in a variety of states and sizes.

Also, oral sex being an act of using the mouth, lips, and tongue to stimulate the female genitals became acceptable in many cultures. Oral sex is often accompanied by the insertion of fingers or a sexual aid into the vagina and/or into the anus, which allows simultaneous stimulation of the receptors in sexual pleasure zones, which many women consider capable of producing very intense experiences.

However, the available .sexual aid devices, such as dildos and vibrators fail to emulate the human penis physiological behaviors, since they require manual activation and deactivation, which deteriorates the sexual experience.

WO 2013/098824 discloses a sexual aid device which comprises a hollow flexible penis body with a plurality of telescopic sections for causing the penis body to be in its erected state when the telescopic sections are maximally propagated and for allowing the penis body to be in its descended default state, when the telescopic sections are maximally contracted: a simulated scrotum made of flexible or semi-rigid material, with a compartment for containing means for powering the propagation and contraction of the telescopic sections; means for providing a driving force required for powering the propagation and contraction of the telescopic sections; sensors located on the penis body, for detecting physical contact of the penis body with the body of the second party; a controller for controlling the driving force to cause the telescopic sections to maximally propagate, according to input signals received from the sensors and to time and to return to be maximally contracted, after a predetermined time; a power source for powering the controller and for generating the driving force; and means for attaching the sexual aid device to the body of the first party. However, the erected state of disclosed sexual aid device is initiated by physical constant between adjacent conducting elements and is therefore, not sufficiently sensitive.

It is therefore an object of the present invention to provide a sexual aid device, which emulate the human penis physiological behavior, which is automatically activated and deactivated when used on a human male body upon being in contact with the female (or another second party) sexual areas.

It is another object of the present invention to provide a sexual aid device, which emulate the human penis physiological behavior, which has high sensitivity to human touch.

Other purposes and advantages of the invention will appear as the description proceeds.

### SUMMARY OF THE INVENTION

The present invention is directed to a sexual aid device, for allowing a User being a first party of sexual relationship with a second party, to simulate the physiologic reaction of the penis of a human male. In one embodiment, the sexual aid device comprises:

a) a hollow penis body made of flexible or semi-rigid material and containing an inflatable air or fluid tube for causing the penis body to be in its erected state when the inflatable air or fluid tube is maximally inflated and for allowing the penis body to be in its descended default state, when the inflatable air or fluid tube is deflated;

b) a simulated scrotum made of flexible or semi-rigid material, having a compartment tor containing means for controlling the inflation and deflation of the air or fluid tube;

c) a pump for inflating the air or fluid tube;

d) a controllable valve for deflating the air or fluid tube;

e) one or more sensors located on the penis body, for detecting physical contact of the penis body with the body of the second party;

f) a controller for:

controlling the controllable valve to be closed and the pump to inflate the air or fluid tube up to a maximal pressure, according to input signals received from the sensors and to deflate;

controlling the controllable valve to be open and deflate the air or fluid tube, according to different input signals received from the sensors;

f) a power source for powering the controller, the pump, the valve and at least one sensor; and

g) means for attaching the sexual aid device to the body of the first party.

At least one of the sensors may be selected from the group of:

a capacitive sensor, for detecting changes in the capacitance of an electric circuit in response to human touch;

a humidity sensor;

a temperature sensor;

a pressure sensor;

a conduction sensor.

The controller may include a processor for analyzing the indicative signals received from the sensors and for activating an erected state according to the results of the analysis.

The flexible or semi-rigid material may be selected from the group of:

silicon;

Rubber;

Plastic;

Latex (a stable dispersion (emulsion) of polymer microparticles in an aqueous medium).

The moans for attaching the sexual aid device to the body of the first party may be a belt or a sling with an appropriate buckle. The first party may be a sex doll.

The sexual aid device may be implemented as an integral part of the body of the sex doll.

The inner cavity of the penis body may be used as the inflatable tube.

The controller may be implemented as an integrated circuit.

The present invention is also directed to a sexual aid device, for allowing a user being a first party of sexual relationship with a second party, to simulate the physiologic reaction of the penis of a human male, comprising:

a) a hollow penis body made of flexible or semi-rigid material and containing an filler for causing the penis body to be in its erected state when the filler is in its maximally contracted or compressed state and for allowing the penis body to be in its descended default state, when the filler is in its relaxed state;

b) a simulated scrotum made of flexible or semi-rigid material, having a compartment for containing means for controlling the contraction or compression of the filler;

c) one or more sensors located on the penis body, for detecting physical contact of the penis body with the body of the second party;

d) a mechanism for varying the contraction or compression level of the filler;

e) a controller for controlling the contraction or compression of the filler up to a predetermined level, according to input signals received from the sensors;

f) a power source for powering the controller, the mechanism and at least one sensor; and

g) moans for attaching the sexual aid device to the body of the. first, party.

The filler may he selected form the group of:

An air or fluid tube;

A set of tubular segments which receive a spring, the central axis of which essentially coincides with the central axis of tubular segments, the tubular segments are capable of being attached to each other by a tensed cable;

Inflatable fluid balloons;

Elastic balls capable of being compressed by a piston.

### BRIEF DESCRIPTION OF THE DRAWINGS

The invention will now be described in connection with certain preferred embodiments with reference to the following illustrative figures so that it may be more fully understood. In the drawings:

FIG. 1 illustrates an example of the deployment of several capacitance sensors on the penis body, according to one embodiment of the present invention;

FIG. 2 illustrates an example of the deployment of several humidity and temperature sensors on the penis body, according to one embodiment of the present invention;

FIG. 3. illustrates an example of the deployment of pressure sensors on the penis body, according to one embodiment of the present invention;

FIG. 4 shows a possible location of rigid sensors;

FIG. 5 schematically illustrates the mechanism of the sexual aid device in its erected state, according to an embodiment of the invention;

FIGS. 6a and 6b illustrate a cable mechanism for obtaining erection, according to an embodiment of the invention;

FIGS. 7a and 7b illustrate a piston mechanism for obtaining erection, according to an embodiment of the invention; and

FIGS. 8a-8c illustrate a inflating mechanism for obtaining erection, according to an embodiment of the invention.

### DETAILED DESCRIPTION OF PREFERRED EMBODIMENTS

The present invention discloses a sexual aid device for sexual stimulation purposes, which is automatically operated when being in contact with an organ or area of the user's body.

The sexual aid device proposed by the present invention is adapted to change its state automatically, from a descended state, to an erected state, and vice versa, so as to simulate the human penis physiological behaviors automatically and with high sensitivity. The proposed sexual aid device includes an electro-pneumatic mechanism that simulates the human male physiologic reaction of the his penis, upon coming in contact with the female sexual organ or other body parts. The basic mechanism for transition between a descended state to an erected state and vice versa includes a controller that received indicative signals from a set of sensors that are deployed along the outer surface of the penis body and activating each state, in response to indications from these sensors. The controller controls the operation of an air or fluid pump or a fluid pump and a valve, which cause inflation or deflation of an elongated pneumatic tube that when inflated, drives the penis hotly to be in its erected state, and when deflated, drives the penis body to be in its descended state.

Sensing of any contact between the penis body and the body of the second party acts is carried out by one or more capacitive sensors, which are deployed on the penis body.

High sensitivity is achieved based on the fact that the human body (an in this case, the body of the second party) acts like an equivalent electric capacitor, which is introduced between any exposed point on the human's organ and ground. As long as the penis body is electrically isolated, the capacitive sensor will sense an initial (predetermined) capacitance which corresponds to a descended state. Upon initiating sexual activity, the penis body is no longer isolated and becomes in contact with the (exposed) body of the second party. At this point, this equivalent electric capacitor will be connected in parallel to the initial capacitance. This causes a substantial change in the overall capacitance sensed by the capacitive sensor and this change serves as a trigger for the penis body to switch to its erected state, as will be explained later on.

The sexual aid device comprises a hollow penis body made of a flexible or semi-rigid material, which is adapted to receive a filler for hardening it when a sexual act is desired. The tiller may be an air or fluid tube, a set of tubular segments which receive a spring, the central axis of which essentially coincides with the central axis of tubular segments, such that these tubular segments are capable of being attached to each other by a tensed cable, a plurality of inflatable fluid balloons, or elastic balls capable of being compressed by a piston. The filler has a mechanism with two states: an aligned, rigid (erected) state and a relaxed (loose) state.

A controller controls the mechanism to be in its aligned, rigid state when erection is desired, in order to fill and harden the penis body. The controller controls the mechanism to be in its loose slate when erection is not desired, in order to allow the penis body to return to its normal orientation.

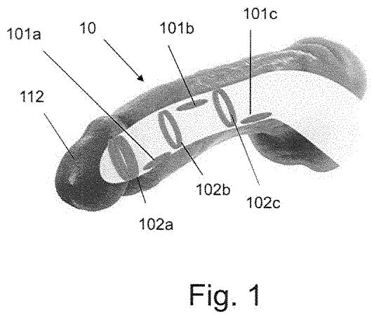

FIG. 1 illustrates an example of the deployment of several capacitance sensors on the penis body, according to one embodiment of the present invention. In this example, the penis body 100 includes three spot sensors 101a-101c and three annular sensors 102a-102c. all of which are deployed along the penis body. The surface area of each sensor determines its touching sensitivity, where larger area increases the sensitivity. In this example, the annular sensor 102a which is closer to the glans of the penis has enlarged surface area, so as to increase the sensitivity in the distal end of the penis body (which is most likely to be stimulated first). In another embodiment, an impending sexual activity, such as an intercourse or an oral sex act, may he detected by a combination of humidity and temperature sensors.

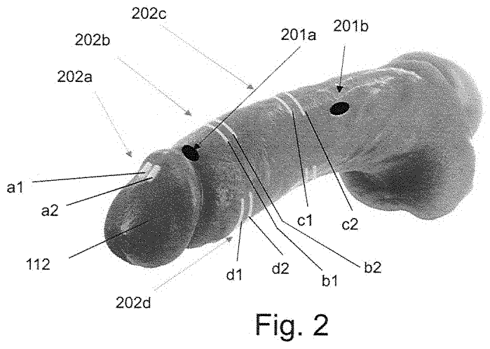

FIG. 2 illustrates an example of the deployment of several humidity and temperature sensors on the penis body, according to one embodiment, of the present invention. In this example, two temperature sensors 201a and 201b are deployed along the upper surface of the penis body (which is more likely to be first in contact with the second party), in order to detect a physical contact that may be an indication about impending sexual act. due to the fact that at least one of the temperature sensors 201a-201b will show temperature that is close to the temperature of a human body (about 36° C.). However, in most cases, the initiation of a sexual act also involves contact of the penis body with wet organs of the second party, such as woman's vagina. Therefore, several humidity sensors 202a-202c are also deployed along the penis body, such that each humidity sensor 202a-202d is implemented by a pair of adjacent electrodes (a1; a2), (b1; b2) and (c1; c2), respectively. Electrodes (a1; a2) of humidity sensor 202a are located on the glans 112. which is firstly exposed to humidity of the vagina. Upon an attempt to initiate an intercourse, the glans 112 touches the vulva and becomes wet due to natural secretion from the vagina during sexual stimulation. Since the natural secretion is electrically conductive, there will be an electric contact between electrodes (a1; a2), which serves as an indication signal that the glans is in contact with the vulva. This indication signal and the temperature reading are both processed by the controller, in order to make a decision about an actual impending act and in response, initiate transition to an erected state. The processing of both indications (temperature and humidity) reduces the chance of false initiation of transition to erected state (which may happen if decision is made based only on one indication). More pairs of electrodes may be deployed for increasing the sensitivity to humidity detection. For example, the electrodes may also be annular and may be exposed in several locations around the penis body (for example, segments d1; d2 that belong to humidity sensor 202d).

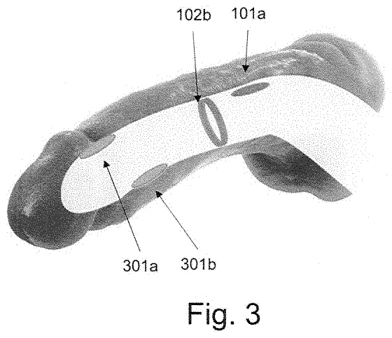

FIG. 3 illustrates an example of the deployment of pressure sensors on the penis body, according to one embodiment of the present invention. In this example, two pressure sensors 301a and 301b are deployed along the surface of the penis body, in order to detect a physical contact that may be an indication for impending sexual act, in addition to the already deployed capacitance sensors 101a and 102b. These pressure sensors are capable of detecting pressing on the outer surface of the penis body and provide indications (in the form of electric signals that are forwarded to the controller) about the pressing location and magnitude, for example, as a result of hand touch or fingers of the second party. The pressure sensors may be for example, piezoelectric sensors which provide signals that are proportional to the pressing magnitude.

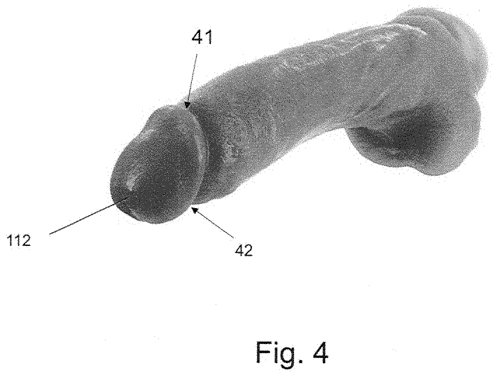

In some cases, sensors such as temperature sensors, pressure sensors and humidity sensors may be rigid and as a result, may harden the local texture of the penis body in their close vicinity. In this case, it is possible to reduce the local hardening effect by locating the rigid sensors adjacent to the edge of the glans 112 (locations 42 and 42). as shown in FIG. 4.

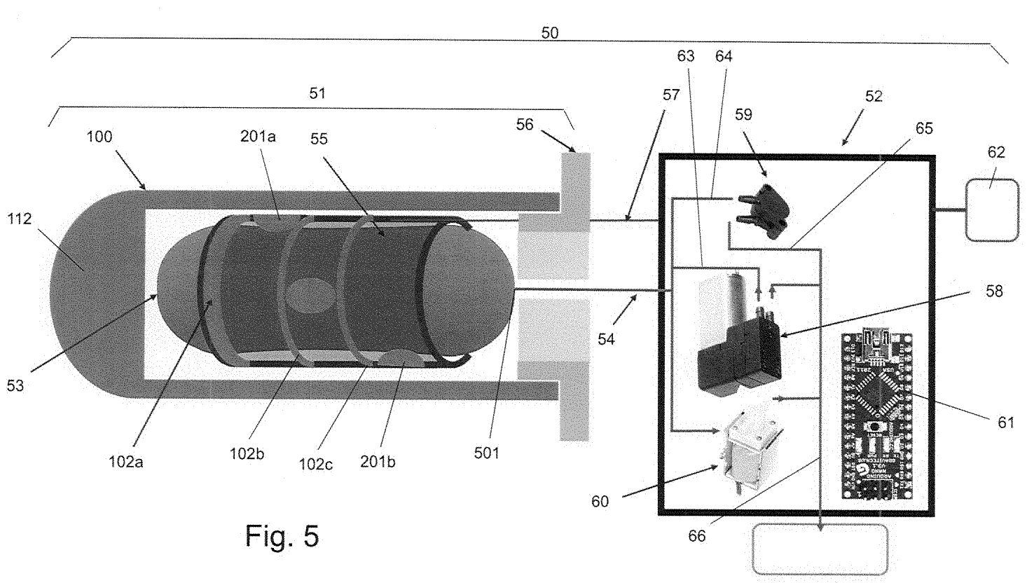

FIG. 5 schematically illustrates the mechanism of the sexual aid device in its erected state, according to an embodiment of the invention. The mechanism simulates the male's penis erection and its physiologic reaction, whenever the sexual aid device becomes in contact with the female sexual organ or body parts.

The sexual aid device 50 consists of a penis section 51 and a control circuit 52, which may be contained in an artificial scrotum. The penis section 51 includes a hollow penis body 100 made of flexible material (such as rubber, plastic, Latex or silicon) that is attached to a docking element 56, which is wearable by an “active” user (the first party) by attaching the docking element 56 to the body (e.g., by a fastened belt). The hollow penis body 100 includes a cavity which contains an inflatable (elongated) pneumatic tube 53 that when inflated, drives the penis body to be in its erected state, and when deflated, drives the penis body 100 to be in its descended state. The pneumatic tube 53 has a proximal end with an orifice 501 which is fed by an air or fluid pipe 54, which is used to inflate or deflate tube 53. A tubular sleeve 55 wraps tube 53, in order to limit its enlargement in the radial direction, so as to maintain a tubular form of the penis body 100 when being maximally inflated. The collection of sensors (e.g., capacitance sensors 1a-102c, temperature sensors 201a and 201b or pressure sensors) are located on the surface of tubular sleeve 55 and optionally at the base of the glans 112. A bundle 57 of wires from all sensors conveys the signals generated by the sensors into control circuit 52.

Control circuit 52 includes an air or fluid pump 58, an air pressure sensor 59, a controllable valve 60 and a controller 61. All components of control circuit 52 are fed by an electric power source 62 (e.g., a battery which may be rechargeable).

Air or fluid pump 58 is controlled by controller 61 and is connected to air or fluid pipe 54 via pipe 63, in order to inflate tube 53 when activated. Pressure sensor 69 continuously reads the pressure in tube 53 via pipes 64 and 65 and forwards the reading to controller 61. Controllable valve 60 is also connected to pipe 54, in order to deflate tube 53 upon receiving a command from controller 61, in order to drive penis body 100 to be in its (default) descended state, when necessary.

Upon activating the sexual aid device 50 by the user (by a switch that connects the power source 62 to the control circuit 52), the sexual aid device 50 becomes active, with optional LED indication (not shown). As long as there is no indication about impending sexual act from one of the sensors, controller 61 does not activate air or fluid pump 58 and the sexual aid device 50 remains in a standby mode, where the penis body 100 is in its (default) descended state. Upon receiving indications (in the form of indicative signals) about impending sexual act from one (or more) of the sensors (e.g., as a result of touching the penis body 100 by an organ of the second party), controller 61 processes the received signals and makes a decision whether or not the received signals show that there is actual touching of the penis body, which corresponds to the initiation of an impending sexual act. Such a decision may he made according to predefined rules of a software application which is programmed in the controller 61.

Upon making a decision that an impending sexual act has been initiated., controller 61 closes valve 60 and sends a command to pump 58 to inflate tube 53 via pipes 63 and 54 until the air pressure (which is read by pressure sensor 59) corresponds to maximally erected state of penis body 100, which is defined by a predetermined pressure. At this (joint, controller 61 will terminate the inflation.

As long as the received indicative signals show that the physical touch continues (e.g., by reading the temperature sensors and humidity sensors, which may be indications that the penis body is inside the vagina), the erected state will be maintained. The erected state may be accompanied by an optional LED indication (e.g., by switching color).

Upon receiving indications that the physical touch discontinued (e.g., by reading the temperature sensors and humidity sensors, which may be indications that the penis body has been pulled out from the vagina), controller 61 will send a command to valve 60 to switch to its open state and to thereby let the compressed air inside tube 53 to deflate via discharge pipe 66 to the open air. By doing so, tube 53 shrinks and the penis body returns to its descended state.

According to another embodiment, upon making a decision that an impending sexual act has been initiated, controller 61 closes valve 60 and sends a command to pump 58 to inflate tube 53 via pipes 63 and 54 until the air pressure (which is read by pressure sensor 59) corresponds to semi-erected state of penis body 100. Then the controller 61 waits for receiving further indications about a desired erection and only after receiving thorn, the controller 61 commands pump 58 to complete erection by reaching full air pressure.

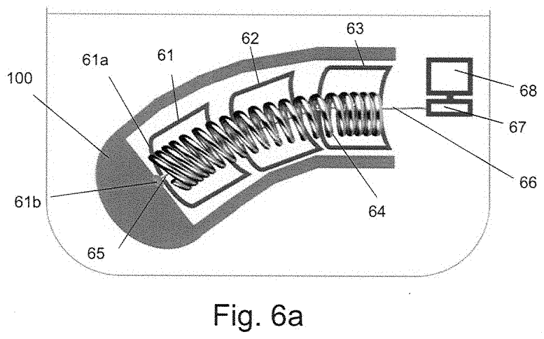

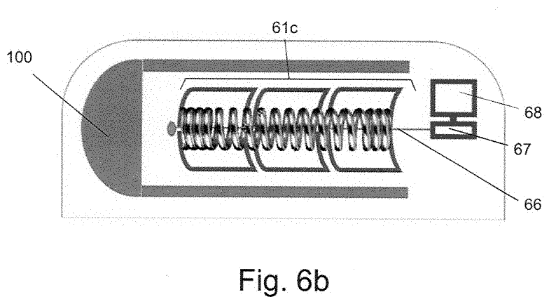

FIGS. 6a and 6b illustrate a cable mechanism for obtaining erection, according to an embodiment of the invention.

Looking first at FIG. 6a, the inflatable tube is replaced with a set of tubular segments 61-63 (may be more), which receive a spring 64, the central axis of which essentially coincides with the central axis of tubular segments 61-63. The distal segment 61 has a closed face 61a with a hole 65. A cable 66 is inserted into the hole 65, such that its distal end is terminated with a flange 61b that cannot pass through hole 65. Its proximal end is connected to a winch 67 that is connected to a controllable motor 68.

As long as there is no sexual activity, motor 68 is controlled to rotate the winch 67 in a direction that reduces the tension of cable 66, such that spring 64 is in its relaxed state. As a result, the spring 66 bends downwardly, such that the distal segments 61-62 are inclined and cause the penis body 100 to be in its descended state.

Upon detecting (by one or more of the sensors) a physical contact that may be an indication for impending sexual act, motor 68 is controlled to rotate the winch 67 in an opposite direction that increases the tension of cable 66, such that spring 64 becomes more and more contracted, until it is fully contracted. As a result, the spring 66 becomes straight and pushes all tubular segments 61-63 to be strongly attached to each other, to thereby form a rigid tubular structure 61c, as shown in FIG. 6b. As long as the sexual act continues, cable 66 remains fully tensioned, such that the penis body 100 is forced to he in its erected state. It is possible to use a joint mechanism with a tension pulley in order to obtain the desired cable tension.

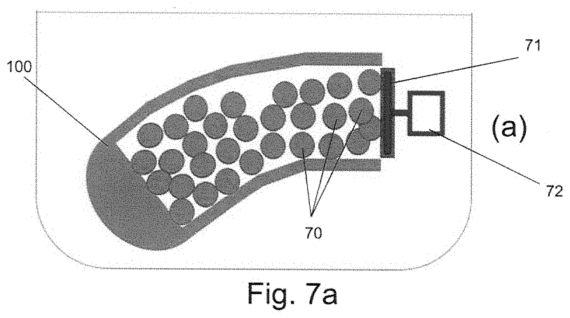

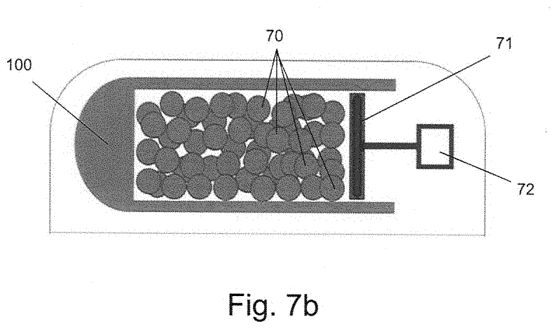

FIGS. 7a and 7b illustrate a piston mechanism for obtaining erection, according to an embodiment of the invention.

Looking first at FIG. 7a, the penis body 100 is made of semi-rigid material and is filled with a plurality of elastic balls 70 (which replace the inflatable tube) that occupy most of its volume. The proximal orifice of the penis body 100 receives a tubular flange that 71 that is displaced forwardly or rearwardly by an appropriate mechanism 72. such as a motor or a piston (not shown) that are controlled by a controller. The diameter of tubular flange 71 is a bit smaller than the inner diameter of the penis body, in order to allow compression of the elastic balls 70, when desired.

As long as there is no sexual activity, mechanism 72 is controlled to align flange 72 essentially with the proximal orifice of the penis body 100, such that balls 70 are loose and not pushed against each other. As a result, the penis body 100 bends downwardly (due to gravitation), thereby causing the penis body 100 to be in its descended state.

Upon detecting (by one or more of the sensors) a physical contact that, may be an indication for impending sexual act, mechanism 72 is controlled to push flange 72 forwardly through the orifice of the penis body 100, such that balls 70 are pushed against each other and are essentially compressed (up to a desired pressure), to form a rigid compressed bulk.

As a result of the applied pressure, the penis body is filled with compressed balls, to thereby form a rigid tubular structure, as shown in FIG. 7b. As long as the sexual act continues, flange remains in its forward position, such that the penis body 100 is forced to be in its erected state.

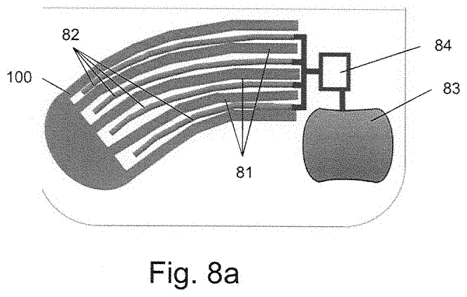

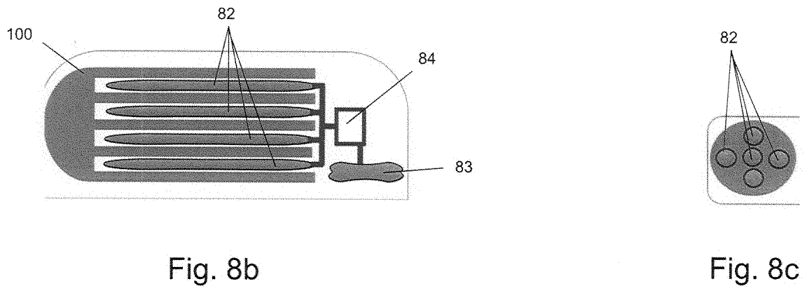

FIGS. 8a-8c illustrate a inflating mechanism for obtaining erection, according to an embodiment of the invention. looking first at FIG. 8a, the penis body 100 is made of semi-rigid material and its inner part is partitioned into several elongated cavities 80 that are separated by walls 81 that are formed by the semi-rigid material outside the cavities. Each elongated cavity 80 received an inflatable balloon 82 that is connected to a controlled pump 83 via a controlled valve 84.

As long as there is no sexual activity, pump 83 is inactive and balloons 82 are empty. As a result, the penis body 100 bends downwardly (due to gravitation), thereby causing the penis body 100 to be in its descended state.

Upon detecting (by one or more of the sensors) a physical contact that may be an indication for impending sexual act, valve 84 is open and pump 83 fills all balloons 82 with compressed air (up to a desired pressure), to form a rigid compressed bulk. Then valve 84 closes to maintain the air pressure to thereby form a rigid tubular structure, as shown in FIG. 8b. As long as the sexual act continues, valve 84 remains closed, such that the penis body 100 is forced to be in its erected state. The valve 84 opens and deflates the compressed air at the end of the sexual act (e.g., when there is no indication of physical contact from one of the sensors). FIG. 8c is a rear view of the penis body in its erected state, when the balloons 82 are filled.

Of Course, the balloons may be filled with and fluid rather that with air.

It is possible to control the angle of the penis body by increasing or decreasing the air pressure, as desired.

In one embodiment, the shell of the penis body 100 can be used as an inflatable air or fluid tube.

Although the examples above used the terms air, air tube and air pump, it should be mentioned that the invention is not limited to air or gas, but any other fluid may be used as a filler, instead if air. In this case, the air or fluid tube can be replaced by a fluid tube and the air pump can be replaced by a fluid pump.

While some embodiments of the invention have been described by way of illustration, it will be apparent that the invention can he carried out with many modifications, variations and adaptations, and with the use of numerous equivalents or alternative solutions that are within the scope of persons skilled in the art, without exceeding the scope of the claims.

1. A sexual aid device, for allowing a user being a first party of sexual relationship with a second party, to simulate the physiologic reaction of the penis of a human male, comprising:
a) a hollow penis body made of flexible or semi-rigid material and containing an inflatable air or fluid tube for causing said penis body to be in its erected state when said inflatable air or fluid tube is maximally inflated and for allowing said penis body to be in its descended default state, when said inflatable air or fluid tube is deflated;
b) a simulated scrotum made of flexible or semi-rigid material, having a compartment for containing means for controlling the inflation and deflation of said air or fluid tube;
c) a pump for inflating said air or fluid tube;
d) a controllable valve for deflating said air or fluid tube;
e) one or more sensors located on said penis body, for detecting physical contact of said penis body with the body of said second party;
f) a controller for:
controlling said controllable valve to be closed and said pump to inflate said air or fluid tube up to a maximal pressure, according to input signals received from said sensors and to deflate;
controlling said controllable valve to be open and deflate said air or fluid tube, according to different input signals received from said sensors;
g) a power source for powering said controller, said pump, said valve and at least one sensor; and
h) means for attaching said sexual aid device lo the body of said first party.

2. A sexual aid device according to claim 1, in which at least one of the sensors is selected from the group of:
a captive sensor, for detecting changes in the capacitance of an electric circuit in response to human touch;
a humidity sensor;
a temperature sensor;
a pressure sensor;
a conduction sensor.

3. A sexual aid device according to claim 1, in which the controller includes a processor for analyzing the indicative signals received from the sensors and for activating an erected state according to the results of the analysis.

4. A sexual aid device according to claim 1, in which the flexible or semi-rigid material is selected from the group of:
silicon;
rubber;
plastic;
Latex.

5. A sexual aid device according to claim 3, in which the means for attaching said sexual aid device to the body of the first party are a belt or a sling with an appropriate buckle.

6. A sexual aid device according to claim 1, in which the first party is a sex doll.

7. A sexual aid device according to claim 6, implemented as an integral part of the body of the sex doll.

8. A sexual aid device according to claim 1, in which the inner cavity of the penis body is used as the inflatable tube.

9. A sexual aid device according to claim 1, in which the controller is implemented as an integrated circuit.

10. A sexual aid device, for allowing a user being a first party of sexual relationship with a second party, to simulate the physiologic reaction of the penis of a human male, comprising:
a) a hollow penis body made of flexible or semi-rigid material and containing an filler for causing said penis body to be in its erected state when said filler is in its maximally contracted or compressed state and for allowing said penis body to be in its descended default, state, when said filler is in its relaxed state;
b) a simulated scrotum made of flexible or semi-rigid material, having a compartment for containing means for controlling the contraction or compression of said filler;
c) one or more sensors located on said penis body, for detecting physical contact of said penis body with the body of said second party;
d) a mechanism for varying the contraction or compression level of said filler;
e) a controller for controlling the contraction or compression of said filler up to a predetermined level, according to input signals received from said sensors;
f) a power source for powering said controller, said mechanism and at least one sensor; and
g) means for attaching said sexual aid device to the body of said first party.

11. A sexual aid device according to claim 10, in which the controller is implemented as an integrated circuit.

12. A sexual aid device according to claim 10, in which the filler is selected form the group of:
an air or fluid tube;
a set of tubular segments which receive a spring, the central axis of which essentially coincides with the central axis of tubular segments, said tubular segments are capable of being attached to each other by a tensed cable;
Inflatable fluid balloons;
Elastic balls capable of being compressed by a piston.
